(19) United States
(12) Patent Application Publication
(10) Pub. No.: US 2008/0259067 A1
(43) Pub. Date: Oct. 23, 2008

(54) METHOD FOR ADJUSTING BACKLIGHT BRIGHTNESS AND ELECTRONIC DEVICE USING THE SAME

(75) Inventors: CHUNG-JEN WANG, Tu-Cheng (TW); LI-SHENG SHU, Shenzhen (CN); TSUNG-JEN CHUANG, Tu-Cheng (TW); SHIH-FANG WONG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/767,480

(22) Filed: Jun. 23, 2007

(30) Foreign Application Priority Data
Apr. 20, 2007 (CN) 200710200486.3

(51) Int. Cl. G06F 3/038

(52) U.S. Cl. 345/207

(57) ABSTRACT

A method for adjusting backlight brightness of a screen, including the following steps of: detecting a brightness of ambient light; collecting the ambient light; adjusting a proportional ratio between collected light and light emitted from an internal light source according to the brightness of the ambient light; coupling the collected light with the light emitted from the internal light source according to the proportional ratio. An electronic device using the method is also disclosed.

### BACKGROUND OF THE INVENTION

1. Field of the Invention

The present invention generally relates to a method for adjusting backlight brightness of a screen and an electronic device using the method.

2. Description of Related Art

In various electronic devices, such as cellular phones, personal digital assistants, and audio/video players, screens are utilized to display information.

Light-emitting diodes (LEDs) are usually used as backlight sources for the screens of the electronic devices. Since the brightness of the LEDs is limited, when the screens are exposed under strong light, such as strong sunlight, the screens would not be able to provide enough brightness in contrast with the strong light. Thereby, information displayed on the screens is difficult to recognize.

Therefore, a method for adjusting the backlight brightness of the screen so that the displayed information can be recognized even in bright sunlight, and an electronic device using the method are needed in the industry.

### SUMMARY OF THE INVENTION

A method for adjusting backlight brightness of a screen, including the following steps of: detecting a brightness of ambient light; collecting the ambient light; adjusting a proportional ratio between collected light and light emitted from an internal light source according to the brightness of the ambient light; coupling collected light with light emitted from the internal light source according to the proportional ratio.

An electronic device includes a screen for displaying information, the screen including a display panel and a backlight system including an internal light source for providing a part of the backlight and a collector unit for collecting ambient light, the collected light and the internal light provided by the internal light source being coupled for providing the backlight for the display panel; a detector for detecting a brightness of the ambient light, and generating a brightness signal; and a controller for generating a control signal according to the brightness signal, the backlight system adjusts a proportional ratio between the collected light and the internal light according to the control signal.

Other systems, methods, features, and advantages of the present method and electronic device will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present method and electronic device can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a block diagram of an electronic device in accordance with an exemplary embodiment;

FIG. 2 is a detailed structure of the screen in FIG. 1;

FIG. 3 is a block diagram of the processor in FIG. 1;

FIG. 4 is a schematic diagram of a relationship between the brightness of the ambient light and the percentage of the internal light;

FIG. 5 is a flowchart of a method for controlling backlight brightness of a screen.

### DETAILED DESCRIPTION OF THE INVENTION

Reference will now be made to the drawings to describe exemplary and preferred embodiments of the present electronic device and method.

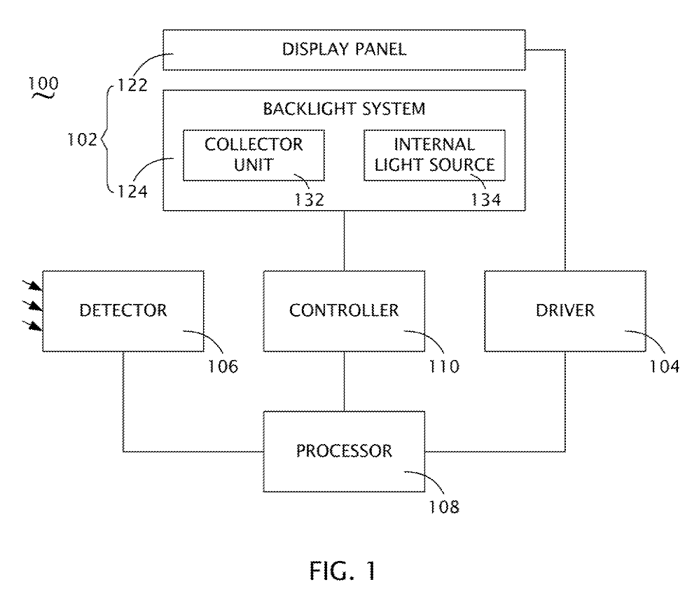

Referring to FIG. 1, an electronic device 100 includes a screen 102, a driver 104, a detector 106, a processor 108, and a controller 110.

The screen 102 is used for displaying information, the information including texts, images, audio/video contents, and so on. The screen 102 includes a display panel 122 and a backlight module 124. Pixels of the display panel 122 can be controlled to allow or disallow backlight through.

The backlight module 124 includes a collector unit 132 and an internal light source 134. The internal light source 134 is used for emitting light as a first light source of the backlight. The collector unit 132 is used for collecting ambient light as a second light source of the backlight. The ambient light that is collected by the collector unit 132 (hereinafter referring as “collected light”) acts as a supplement for the light emitted from the internal light source 134 (hereinafter referring as “internal light”). The collected light and internal light are coupled, to provide sufficient backlight for the display panel 122.

The driver 104 is used for generating the drive signal according to the information that is to be displayed on the screen 102, thus controlling the pixels of the screen 102.

The detector 106 is used for performing a brightness detection of the ambient light. The detector 106 generates a brightness signal based on the brightness detected, and sends the brightness signal to the processor 108.

The processor 108 receives the brightness signal, and performs a light compensation calculation according to the brightness signal to determine a proportion of the collected light as a percentage of the backlight. The processor 108 is also used for providing the information that is to be displayed on the screen 102 to the driver 104.

After the processor 108 performs the light compensation calculation, the processor 108 sends compensation instructions to the controller 110. The controller 110 receives the compensation instructions, and sends a control signal to the backlight system 124. The backlight system 124 adjusts the proportional ratio of the collected light in the backlight according to the control signal.

Preferably, the backlight system 124 adjusts the proportional ratio by modulating the internal light source 134. As presented in Table 1, the brightness of the collected light (hereinafter refers as “external brightness”), the brightness of the internal light (hereinafter refers as “internal brightness”), the brightness of the backlight that is a combination of the collected light and the internal light (hereinafter refers as “the backlight brightness”), and the percentage of the internal light in the backlight are illustrated.

TABLE 1

| | | | |
|---|---|---|---|
| External Brightness (lumen) | 500 | 2000 | 10000 |
| Internal Brightness (lumen) | 300 | 200 | 100 |
| Backlight Brightness (lumen) | 800 | 2200 | 10100 |
| Percentage of the internal brightness (%) | 37.5 | 9.1 | 1.0 |

As shown in Table 1, as the external brightness increases, the internal brightness is decreased, thus the percentage of the internal light in the backlight is reduced. At the same time, the backlight brightness gets higher with an increase in the external brightness.

Alternatively, in another exemplary embodiment, the backlight system 124 adjusts the proportional ratio by tuning an amount of the collected light that is coupled with the internal light. The backlight system 124 may include an element which is used for allowing a controllable amount of the collected light to pass. Preferably, the element is a grating or a liquid crystal device. The collected light that passes the element is coupled with the internal light. The proportional ratio of the collected light in the backlight can be controlled by utilizing the element.

The electronic device 100 adds the collected light to the internal light, this ensures that the backlight brightness is always higher than the external brightness, in spite of the increase of the external brightness. Therefore, the displayed information of the screen 102 can be recognized in various environments, even under strong sunlight.

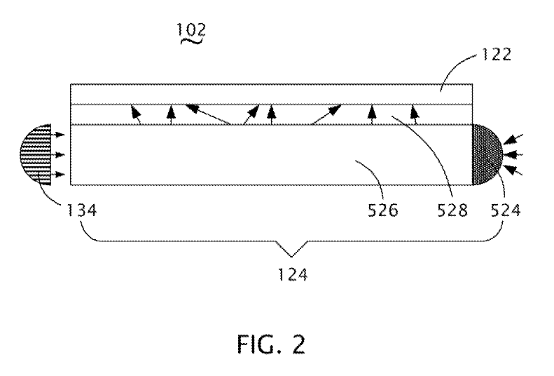

Referring to FIG. 2, a detailed structure of the screen 102 is illustrated. The backlight system 124 includes the internal light source 134, a collector lens 524, a light-guide plate 526, and a diffusion plate 528.

The internal light source 134 is used for providing a part of the backlight for the display panel 132. Preferably, the internal light source 134 is a cold cathode fluorescent lamp (CCFL), or a light emitting diode (LED).

The collector lens 524 is used for collecting the ambient light. The collected light is coupled with the internal light emitted from the internal light source 134, thus providing the backlight for the display panel 122. The collector lens 524 can be a preferred example for the collector unit 132 as shown in the FIG. 1.

The light-guide plate 526 guides the backlight, which is generated by coupling the collected light with the internal light, to spread uniformly to the entire area behind the display panel. Thus the backlight is distributed on a surface also known as surface light. The surface light is projected to the diffusion plate 528.

The diffusion plate 528 is used for diffusing the surface light, and uniformly emitting diffused light to the display panel 122. The diffused light has generally uniform brightness within the area behind the display panel 122.

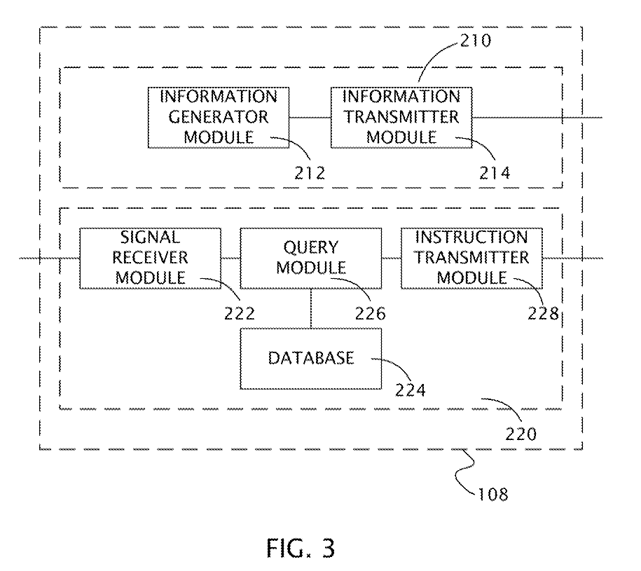

Referring to FIG. 3, the processor 108 includes an image unit 210 and a compensation unit 220. The image unit 210 is used for providing the information for the driver 104. The compensation unit 220 is used for providing the compensation instruction for the controller 110 according to the brightness signal.

The image unit 210 includes an information generator module 212 and an information transmitter module 214. The information generator module 212 generates the information that is to be displayed to the users, and sends the information to the information transmitter module 214. The transmitter module 214 is used for transmitting the information to the driver 104. The driver 104 then generates the drive signal according to the information.

The compensation unit 220 includes a signal receiver module 222, a database 224, a query module 226, and an instruction transmitter module 228.

The signal receiver module 222 is used for receiving the brightness signal from the detector 106, and forwarding the brightness signal to the query module 226.

The database 224 stores a plurality of brightness values and a plurality of proportional ratio values. Each proportional ratio value is corresponding to one of the brightness values.

The query module 226 is used for generating a query instruction according to the brightness signal, and sending the query instruction to the database 224.

In response to the query instruction that is sent from the query module 226, the database 224 provides a query result. The query result includes a proportional ratio value corresponding to the external brightness.

On receiving the query result that is provided by the database 224, the query module 226 generates a compensation instruction. The compensation instruction determines whether the collected light is going to be coupled in the backlight, and the proportional ratio that the collected light is coupled with the internal light. The compensation instruction is sent to the instruction transmitter module 228.

The instruction transmitter module 228 is used for transmitting the compensation instruction to the controller 110. The controller 110 receives the compensation instruction, and generates a control signal accordingly, and sends the control signal to the backlight system 124.

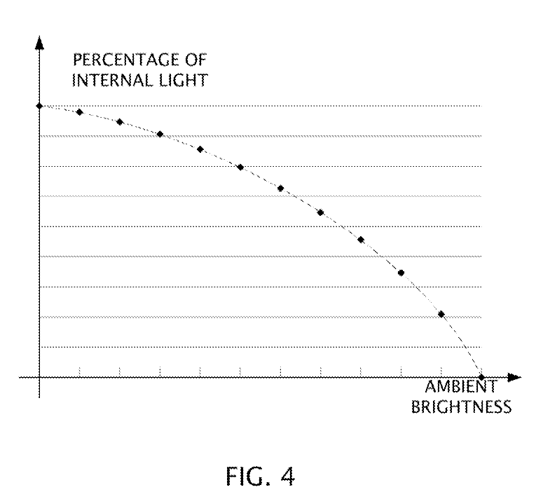

Referring to FIG. 4, a schematic diagram of a relationship between the external brightness and the percentage of the internal light in the backlight is illustrated. The percentage of the internal light decreases as the external brightness increases, thus the percentage of the collected light in the backlight increases.

When the external brightness is rather high, the internal brightness is far less than the external brightness. Thus, the backlight is mainly provided by the collected light, and the internal light accounts a rather small part of the backlight. When the external brightness is high enough, it is possible that the backlight is provided entirely by the collected light.

When the external brightness is rather low, the internal brightness could be equivalent to the external brightness. In such situations, it is necessary to increase the percentage of the internal light in the backlight. When the environment is approximately dark, the backlight could be only provided by the internal light, for there is little collected light.

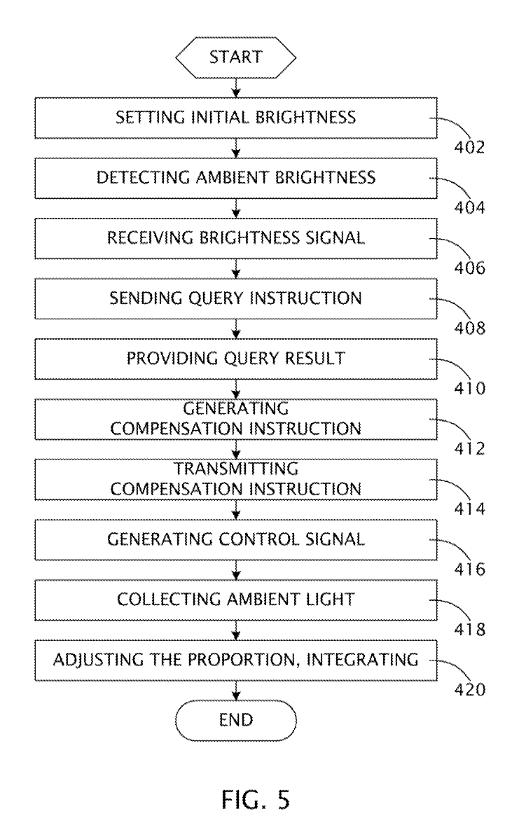

Referring to FIG. 5, a flowchart of a method for controlling the backlight brightness of the screen is illustrated. The electronic device as shown in the FIGS. 1 and 3 is described as a reference.

Step 402, after the electronic device 100 is initialized, the controller 110 sends an initial control signal to the backlight system 124, for setting an initial backlight brightness.

Step 404, the detector 106 detects the external brightness, and generates the brightness signal according to the detection. The brightness signal is transmitted to the signal receiver module 222 of the processor 108.

Step 406, the signal receiver module 222 receives the brightness signal, and transmits the brightness signal to the query module 226.

Step 408, the query module 226 generates the query instruction according to the brightness signal, and sends the query instruction to the database 224.

Step 410, the database 224 provides the query result for the query module 226 in response to the query instruction. The query result includes the proportional ratio value corresponding to the external brightness.

Step 412, the query module 226 generates the compensation instruction according to the query result. The compensation instruction is sent to the instruction transmitter module 228.

Step 414, the instruction transmitter module 228 transmits the compensation instruction to the controller 110.

Step 416, the controller 110 generates the control signal according to the compensation instruction. The control signal is sent to the backlight system 124.

Step 418, the collector unit 132 of the backlight system 124 collects ambient light. The collector unit 132 may be a collector lens 524 as shown in FIG. 2.

Step 420, the backlight system 124 adjusts the proportional ratio of the collected light and the internal light in the backlight according to the control signal, and couples the collected light and the internal light emitted from the internal light source 134, for providing the backlight for the display panel 122.

The electronic device 100 and the method utilizes the collected light as a supplement for the internal light, and couples the collected light and the internal light to provide the backlight for the display panel 122. The backlight brightness is higher than the external brightness in any circumstance, even in bright sunlight. The internal brightness can be adjusted according to the external brightness. This avoids lightening the screen with a constant power, thus power consumption of the screen is lowered.

What is claimed is:

1. A method for adjusting a backlight brightness of a screen, the method comprising the following steps of:
detecting a brightness of ambient light;
collecting the ambient light;
adjusting a proportional ratio between collected light and light emitted from an internal light source according to the brightness of the ambient light;
coupling the collected light with the light emitted from the internal light source according to the proportional ratio.

2. The method as claimed in claim 1, further comprising the following steps of:
query for a proportional ratio value according to the brightness of the ambient light;
providing a query result in response to the query;
adjusting the proportional ratio between the collected light and the light emitted from the internal light source according to the query result.

3. The method as claimed in claim 2, further comprising the following steps of:
generating a control signal according to the query result;
adjusting the proportional ratio between the collected light and the light emitted from the internal light source according to the control signal.

4. The method as claimed in claim 1, further comprising the following steps of:
modulating the internal light source, for adjusting the proportional ratio between the collected light and the light emitted from the internal light source.

5. The method as claimed in claim 1, further comprising the following steps of:
tuning an amount of the collected light that is coupled with the light emitted from the internal light source, for adjusting the proportional ratio.

6. An electronic device comprising:
a display panel for displaying information;
a backlight system for providing backlight for the display panel, the backlight system comprising:
an internal light source for providing a part of the backlight; and
a collector unit for collecting ambient light, the ambient light that is collected by the collector unit and the light provided by the internal light source are coupled, for providing the backlight for the display panel;
a detector for detecting a brightness of the ambient light, and generating brightness signals; and
a controller for generating a control signal according to the brightness signal, the backlight system adjusts a proportional ratio between the ambient light that is collected by the collector unit and the light provided by the internal light source in the backlight according to the control signal.

7. The electronic device as claimed in claim 6, further comprising a processor, the processor comprising:
an image unit for providing information to be displayed for the display panel; and
a compensation unit for receiving the brightness signal, and generating a compensation instruction according to the brightness signal, the controller generates the control signal according to the compensation instruction.

8. The electronic device as claimed in claim 7, wherein the compensation unit comprises:
a database for storing a plurality of brightness values and a plurality of proportional ratio values, each proportional ratio value is corresponding to a brightness value; and
a query module for sending a query instruction to the database according to the brightness signal, and receiving a query result therefrom, the query result comprises a proportional ratio value corresponding to the brightness of the ambient light.

9. The electronic device as claimed in claim 6, wherein the controller adjusts the proportional ratio by modulating the internal light source.

10. The electronic device as claimed in claim 6, wherein the controller adjusts the proportional ratio by tuning an amount of the collected light that is coupled with the light provided by the internal light source.
